(19) United States
(12) Patent Application Publication
(10) Pub. No.: US 2006/0078238 A1
(43) Pub. Date: Apr. 13, 2006

(54) Gas bearing system

(75) Inventor: Theo Anjes Maria Ruijl, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/538,609

(22) PCT Filed: Nov. 21, 2003
(86) PCT No.: PCT/IB03/05448

§ 371 Date: Jun. 10, 2005

(30) Foreign Application Priority Data
Dec. 18, 2002 (EP) 02080386.2

(51) Int. Cl. F16C 32/06

(52) U.S. Cl. 384/100

(57) ABSTRACT

A gas bearing system comprising two opposing and substantially parallel bearing surfaces (2,4) and at least one gas duct (6) for supplying gas to the bearing gap (5) between said bearing surfaces (2,4). A cavity (10,14,15,18,19) having a content between 0.001 cm3 and 0.2 cm³ is present, which cavity is connected to said bearing gap (5) through an orifice (7,11,16,17,20,21). The bearing surfaces (2,4) may comprise a recessed area (13) in which the distance between said two bearing surfaces (2,4) is larger than the distance between said two bearing surfaces (2,4) in the portion of said bearing gap (5) surrounding said recessed area (13).

The invention is related to a gas bearing system comprising two opposing and substantially parallel bearing surfaces and at least one gas duct for supplying gas to the bearing gap between said bearing surfaces.

The gas bearing system may have substantially flat bearing surfaces, so that it can be used to support and guide a member making a translating movement. Such gas bearing systems are frequently used as guiding and supporting elements in high precision machines. The bearing surfaces may also have a cylindrical shape, enabling a rotating member to be supported. Also other shapes—adapted to the relative movement of the bearing surfaces—are possible, for example a spherical shape to support a member making a tumbling movement.

In general, such a gas bearing system must have a relatively high stiffness, but there must also be an effective damping of vibrations in the bearing system, especially in case the gas bearing system is used in high precision machines, like coordinate measuring machines.

However, the volume of the bearing gap in combination with the compressibility of the gas may cause a delay in the response of the bearing pressure to a change in the distance between the bearing surfaces. This delay introduces a negative phase shift, which may result in an unstable bearing system, depending on the frequency of the change of said distance, whereby so called pneumatic hammering may occur.

To increase the load capacity of gas bearing systems, the bearing gap may have a chamber, i.e. a recessed area in one of the bearing surfaces. In said recessed area the distance between the two bearing surfaces is larger than the distance between said two bearing surfaces in the portion of the bearing gap surrounding said recessed area. In that surrounding portion said distance may be for example between 0.005 mm and 0.01 mm, while in the chamber said distance is for example between 0.01 mm and 0.05 mm. Although such chamber increases -the load capacity of the bearing system, it may increase the instability of the gas bearing system caused by the compressibility of the gas in the bearing gap.

The object of the invention is to provide an improvement of gas bearing systems resulting in effective damping of vibrations in the system.

In order to accomplish that objective, the bearing system comprises a cavity having a content between 0.001 cm³ and 0.2 cm³, preferably between 0.001 cm³ and 0.1 cm³, which cavity is connected to the bearing gap through an orifice. Preferably the diameter of the orifice is between 0.05 mm and 0.3 mm, more preferably between 0.1 mm and 0.2 mm.

The cavity is closed at all sides and communicates with the outside only through said orifice, which orifice restricts the gas flow to and from the cavity. If the content of the cavity is so small that a substantial change in gas pressure is generated inside the cavity in response to the changing (vibrating) gas pressure outside the cavity, then the presence of the cavity is able to damp vibrations of the bearing system. Depending on dimensions of the bearing, and the content of the cavity, and the diameter of the orifice, a certain frequency range of vibrations can be damped. For each application the optimal dimensions can easily be found by experimentation.

Although the invention can be advantageously applied in any kind of gas bearing system, very good results are obtained in gas bearing systems where one of the bearing surfaces comprises a recessed area in which the distance between the two bearing surfaces is larger than the distance between said two bearing surfaces in the portion of the bearing gap surrounding said area.

Preferably, more than one cavity is connected to the bearing gap to achieve a more effective damping action. The contents of the different cavities may be equal, but in one preferred embodiment the cavities have a different content, the difference being more than 10%, preferably more than 20%, more preferably more than 50%. By making use of cavities with mutual different contents, a larger frequency range of vibrations or different frequency ranges of vibration can be damped. Furthermore the orifices may have different dimensions, adapted to the dimensions of the bearing gap and the frequency range.

Each cavity may be connected directly with said bearing gap through an orifice, but in another preferred embodiment one of the cavities is connected to another cavity through an orifice, so that said one of the cavities is connected with the bearing gap through said other cavity. Also more than two cavities may be interconnected through orifices, enabling further tuning of the damping action.

The invention will now be explained in more detail by means of a description of four embodiments of a gas bearing system provided with flat bearing surfaces, in which reference is made to a drawing, in which:

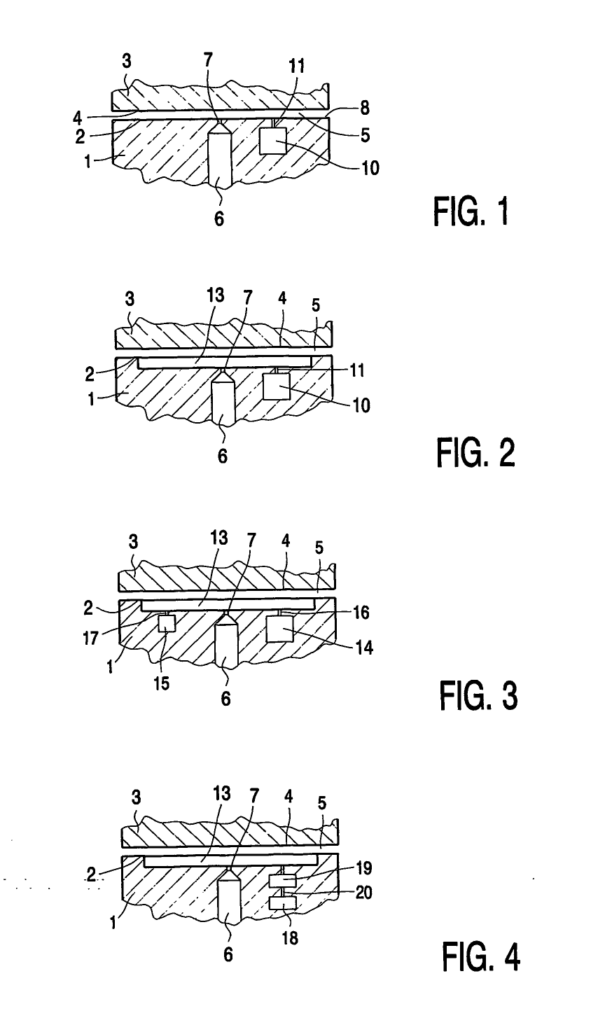

FIG. 1 is a sectional view of a gas bearing comprising one cavity;

FIG. 2 is a sectional view of a gas bearing, one bearing surface being provided with a chamber;

FIG. 3 is a sectional view of a gas bearing comprising two cavities; and

FIG. 4 is a sectional view of another gas bearing comprising two cavities.

The figures are schematic representations of the embodiments, in which some dimensions are out of proportion to achieve a better representation of relevant details. All four figures show a cross section perpendicular to the plane of the substantially flat bearing surfaces.

FIG. 1 shows a first bearing member 1 having a flat first bearing surface 2, and a second bearing member 3 having a flat second bearing surface 4 opposing said first bearing surface 2. The two bearing surfaces 2,4 are parallel. The bearing members 1,3 may be made from metal or plastic or another material.

Between the two bearing surfaces 2,4 there is a bearing gap 5 into which air, or another gas, is brought through air supply duct 6 in bearing member 1. Air supply duct 6 terminates near bearing surface 2 and is connected with bearing gap 5 by an orifice 7 restricting the airflow.

Because of the air pressure in bearing gap 5 the second bearing member 3 is supported by the first bearing member 1 without contact between the two bearing surfaces 2,4. The air cushion in the bearing gap 5 keeps the two bearing members 1,3 apart. The air will escape at the edge 8 of the bearing gap 5, but new compressed air will be supplied to the bearing gap 5 by air duct 6 in order to keep the required air pressure in bearing gap 5.

The first bearing member 1 can be present at a fixed location in a machine, while the second bearing surface 4 of the second bearing member 3 can move over the fixed first bearing surface 2 to guide and support another part of the machine connected to second bearing member 3. Second bearing member 3 is supported by the air cushion in the bearing gap 5 between the two bearing surfaces 2,4.

More than one orifice 7 can be present to supply air to the bearing gap 5 between the two bearing surfaces 2,4 to maintain the air cushion. It is also possible to provide the moving bearing member 3 with an air supply duct instead of the air supply duct 6 in bearing member 1, or additional to air supply duct 6.

The dimensions of the bearing system can be as follows. The bearing surfaces 2,4 may have a dimension of about 20 cm². The distance between the two bearing surfaces 2,4 can be between 0.005 mm and 0.01 mm. The diameter of the orifice 7 can be between 0.1 mm and 0.2 mm, and its length is for example 1 mm.

FIG. 1 shows an embodiment of the gas bearing system comprising one cavity 10 in the first bearing member 1. Cavity 10 is closed at all sides and is connected with the bearing gap by orifice 11. Orifice 11 restricts the airflow from bearing gap 5 to cavity 10 and from cavity 10 to bearing gap 5.

The content of cavity 10 is for example 0.05 cm³ and the orifice 11 has for example a diameter of 0.1 mm and a length of 1 mm. The cavity 10 can be manufactured by drilling a blind bore in the bearing surface 2 of bearing member 1 and filling the entrance of the bore with a cover comprising the orifice 11. Depending on the design other ways for manufacturing the cavity are obvious.

The dimension of the cavity 10 and the orifice 11, in combination with the dimensions and characteristics of the bearing, will result in a damping effect on vibrations of the bearing members 1,3 relative to each other, within a certain frequency range. The optimal dimensions have to be found by experiments rather then by calculations.

FIG. 2 shows an embodiment of a gas bearing system wherein first bearing member 1 is provided with a chamber 13, i.e. a recessed area in bearing surface 2. In the recessed area (chamber 13) the distance between the two bearing surfaces 2,4 is larger than the distance between said two bearing surfaces 2,4 in the portion of the bearing gap 5 surrounding the recessed area 13. In the surrounding portion said distance is for example between 0.005 mm and 0.01 mm, while in the chamber 13 said distance is for example between 0.01 mm and 0.05 mm.

Because of the presence of the chamber 13 the average air pressure in the bearing gap 5 will be higher, so that the same air supply pressure will result in a higher load capacity of the bearing system.

As shown in FIG. 2, the cavity 10 is connected by orifice 11 with the recessed area (chamber 13) of the first bearing surface 2. The dimensions of cavity 10 and orifice 11 can be the same as mentioned above for the embodiment shown in FIG. 1.

FIG. 3 shows an embodiment of a gas bearing system comprising two cavities 14,15, each being connected by an orifice 16,17 to the chamber 13 of the bearing gap 5. The content of cavity 14 is twice the content of cavity 15, so that different frequency ranges shall be damped.

FIG. 4 shows another embodiment of a gas bearing system wherein two cavities 18,19 are present. Cavity 18 is connected by orifice 20 to cavity 19, and cavity 19 is also connected to bearing gap 5 by orifice 21. Such configuration provides possibilities for further tuning the damping action.

The embodiments as described above are merely examples; a great many other embodiments are possible, for example gas bearing systems having cylindrical bearing surfaces, where one of the bearing members rotates around the axis of the cylinder and cavities are present in at least one of the bearing surfaces for damping vibrations in the system. Also other shapes—adapted to the relative movement of the bearing surfaces 2,4—are possible, for example a spherical shape to support a bearing member 3 making a tumbling movement.

1. A gas bearing system comprising two opposing and substantially parallel bearing surfaces (2,4) and at least one gas duct (6) for supplying gas to the bearing gap (5) between said bearing surfaces (2,4), characterized by a cavity (10,14,15,18,19) having a content between 0.001 cm³ and 0.2 cm³, which cavity (10,14,15,18,19) is connected to said bearing gap (5) through an orifice (7,11,16,17,20,21).

2. A gas bearing system as claimed in claim 1, characterized in that the content of the cavity (10,14,15,18,19) is between 0.001 cm³ and 0.1 cm³.

3. A gas bearing system as claimed in claim 1, characterized in that the diameter of said orifice (7,11,16,17,20,21) is between 0.05 mm and 0.3 mm, preferably between 0.1 mm and 0.2 mm.

4. A gas bearing system as claimed in claim 1, characterized in that one of said bearing surfaces (2) comprises a recessed area (13) in which the distance between said two bearing surfaces (2,4) is larger than the distance between said two bearing surfaces (2,4) in the portion of said bearing gap (5) surrounding said recessed area (13).

5. A gas bearing system as claimed in claim 1, characterized in that more than one cavity (10,14,15,18,19) is connected to said bearing gap (5).

6. A gas bearing system as claimed in claim 5, characterized in that the cavities (10,14,15,18,19) have a different content, the difference being more than 10%, preferably more than 20%, more preferably more than 50%.

7. A gas bearing system as claimed in claim 5, characterized in that each cavity (10,14,15,19) is connected directly with said bearing gap through an orifice (7,11,16,17,21).

8. A gas bearing system as claimed in claim 5, characterized in that one of the cavities (18) is connected to another cavity (19) through an orifice (20).

9. A gas bearing system as claimed in claim 8, characterized in that more than two cavities (18,19) are interconnected through orifices (20).
